(19) United States
(12) Patent Application Publication
(10) Pub. No.: US 2017/0193099 A1
(43) Pub. Date: Jul. 6, 2017

(54) Machine Identification of Grammar Rules That Match a Search Query

(71) Applicant: Quixey, Inc., Mountain View, CA (US)

(72) Inventors: Jonathan BEN-TZUR, Sunnyvale, CA (US); Eric GLOVER, Palo Alto, CA (US)

(21) Appl. No.: 15/396,643

(22) Filed: Dec. 31, 2016

Related U.S. Application Data
(60) Provisional application No. 62/273,987, filed on Dec. 31, 2015.

(51) Int. Cl. G06F 17/30

(52) U.S. Cl. CPC G06F 17/30734; G06F 17/30625; G06F 17/30637; G06F 17/30634

(57) ABSTRACT

A search server receives a first grammar rule and a second grammar rule via a network communication device. The first grammar rule specifies a first set of entity types and the second grammar rule specifies a second set of entity types. The intersection of the first and second sets includes at least one entity type. The search server generates a first grammar tree to represent the first grammar rule and a second grammar tree to represent the second grammar rule. The first root node of the first grammar tree and a second root node of the second grammar tree are identical. The search server merges the first and second grammar trees to form a merged grammar tree that represents a union of the first and second sets of entity types. The search server optimizes the merged grammar tree by purging duplicate nodes from each level of the merged grammar tree.

### CROSS-REFERENCE TO RELATED APPLICATIONS

This application claims the benefit of U.S. Provisional Application No. 62/273,987, filed on Dec. 31, 2015. The entire disclosure of the application referenced above is incorporated by reference.

### FIELD

This disclosure relates to identifying grammar rules that match a search query.

### BACKGROUND

Search systems provide search results in response to receiving search queries. A search system can receive a search query from a mobile computing device, a desktop computer, or a server. Some search systems use various rules to determine the search results. Search systems that use rules may compare the search query with each rule to determine whether the rule applies to the search query. If a particular rule applies to the search query, the search system can retrieve search results that correspond with the rule. Since the search system may have to compare the search query with each rule, the amount of time required to generate the search results may depend on the number of rules. Also, some rules may overlap. For example, two of the rules may require the search query to include a movie entity. In this example, the search system may check the search query for the movie entity twice. By checking for the movie entity twice, the search system may waste valuable computing resources. Therefore, there is a need for a search system that checks rules more efficiently.

### SUMMARY

In some examples, the present disclosure is directed to a search server comprising a network communication device, a storage device, and a processing device. The processing device executes computer-readable instructions that, when executed by the processing device, cause the processing device to receive a first grammar rule and a second grammar rule via the network communication device. The first grammar rule specifies a first set of entity types and the second grammar rule specifies a second set of entity types. The intersection of the first set and the second set comprises at least one entity type. The processing device generates a first grammar tree to represent the first grammar rule and a second grammar tree to represent the second grammar rule. The first root node of the first grammar tree and a second root node of the second grammar tree are identical. The processing device merges the first grammar tree and the second grammar tree to form a merged grammar tree that represents a union of the first set of entity types and the second set of entity types. The processing device optimizes the merged grammar tree by purging duplicate nodes from each level of the merged grammar tree.

In some examples, the present disclosure is directed to a computer program product encoded on a non-transitory computer readable storage medium comprising instructions that, when executed by a processing device, cause the processing device to perform operations comprising receiving a first grammar rule and a second grammar rule via a network communication device. The first grammar rule specifies a first set of entity types and the second grammar rule specifies a second set of entity types. The intersection of the first set and the second set comprises at least one entity type. The operations further comprise generating a first grammar tree to represent the first grammar rule and a second grammar tree to represent the second grammar rule. A first root node of the first grammar tree and a second root node of the second grammar tree are identical. The operations further comprise merging the first grammar tree and the second grammar tree to form a merged grammar tree that represents a union of the first set of entity types and the second set of entity types. Additionally, the operations comprise optimizing the merged grammar tree by purging duplicate nodes from each level of the merged grammar tree, receiving a search query via the network communication device, and utilizing the merged grammar tree to determine whether the search query satisfies the first grammar rule and/or the second grammar rule.

In some examples, the present disclosure is directed to a computer-implemented method comprising receiving, at a processing device, a search request via a network communication device. The search request comprises a search query with one or more search terms. The method further comprises tokenizing the search query to generate tokens and generating n-grams from the tokens. Each of the n-grams includes one or more tokens. The method further comprises querying an entity data store stored in a storage device with the n-grams to identify the entity types associated with the n-grams. Additionally, the method comprises generating an augmented inverse chart parse that maps the entity types and the start token positions of the entity types to the end token positions of the entity types. The method further comprises utilizing the augmented inverse chart parse to identify grammar rules that the search query matches.

### BRIEF DESCRIPTION OF THE DRAWINGS

FIG. 1 is a schematic diagram of a search system that provides search results for a search query by identifying grammar rules that match the search query.

FIG. 2A is a diagram of two example grammar trees that are graphical representations of two different grammar rules.

FIG. 2B is a diagram of a merged grammar tree that can be formed by merging the two grammar trees shown in FIG. 2A.

FIG. 3 is a block diagram of a search server that identifies grammar rules that match a search query and provides search results based on the matching grammar rules.

FIG. 4 is a flow diagram of a method that can be executed by the search server to merge different grammar trees in order to form a merged grammar tree.

FIG. 5A is a flow diagram of a method that can be executed by the search server to identify grammar rules that match a search query.

FIG. 5B is a diagram that illustrates an example search query and an example merged grammar tree.

FIG. 5C is a block diagram of a method that can be executed by the search server to identify grammar rules that match a search query.

Like reference symbols in the various drawings indicate like elements.

### DETAILED DESCRIPTION

The present disclosure describes a search server that utilizes grammar rules to provide search results for search queries. Each grammar rule may be associated with information that the search server can use to provide search results. When the search server receives a search query, the search server identifies a grammar rule that matches the search query. Upon identifying a grammar rule that matches the search query, the search server can use the information associated with the grammar rule to generate the search results.

A grammar rule may specify one or more entity types, intent words, and/or modifier words. An entity type refers to a category of physical or logical objects. Examples of entity types are movies, applications, restaurants, etc. Intent words may be words or phrases that are associated with an entity type (e.g., “movie” and “watch” are intent words for movies). Modifier words may be words or phrases that refer to a subset of entities within a set (e.g., “old” in “old movies” may refer to movies that are more than 20 years old). Table 1 illustrates example grammar rules. As shown in Table 1, a first grammar rule may include a movie name and an application name. The search system may determine that a search query satisfies the first grammar rule if the search query includes a movie name and an application name. Similarly, a second grammar rule may include a movie name and an actor name. The search system may determine that a search query satisfies the second grammar rule if the search query includes a movie name and an application name.

TABLE 1
Example Grammar Rules and their corresponding actions

| Grammar | | Action | |
|---|---|---|---|
| Rules | | Categorize Query | Application |
| 1 | [movie name] [app name] | Movie query | App specified in |
| | | | query |
| 2 | [movie name] [actor name] | Movie query | Movie Info app |
| 3 | [restaurant name] . . . | Cuisine query | Restaurant Reviews |
| | | | app |

Each grammar rule may be associated with one or more actions that the search system can perform. An action may refer to a set of computer-readable instructions that the search system can execute. In some examples, the action may include categorizing a search query. Referring to Table 1, if the search system determines that the search query satisfies the first grammar rule and/or the second grammar rule, then the search system can categorize the search query as a movie query. In some examples, the action may include selecting an application that is associated with the grammar rule as a search result. Referring to Table 1, if the search system determines that the search query satisfies the third grammar rule, then the search system may select a restaurant reviews application as a search result (e.g., the YELP® restaurant review application).

As illustrated in Table 1, some grammar rules may overlap with each other. In other words, some grammar rules may include entity types, intent words, and/or modifier words that are common to both grammar rules. Put another way, the intersection of some grammar rules may include one or more entity types, intent words, and/or modifier words. Referring to Table 1, the first and second grammar rules overlap with each other because both require a search query to include a movie name. If the search system first checks the first grammar rule and then the second grammar rule, then the search system is unnecessarily checking the search query for a movie name twice. In general, if the search system includes grammar rules that have overlapping portions, the search system unnecessarily checks the search query multiple times for entity types, intent words, and/or modifier words in the overlapping portions.

In order to eliminate the unnecessary checks, the search system can merge overlapping portions of the grammar rules to form a merged grammar rule and use the merged grammar rule to identify the individual grammar rules that match the search query. The search system can generate a grammar tree for each grammar rule. Each node in a grammar tree can represent an entity type, intent word, or modifier word specified by the grammar rule. The search system can merge the grammar trees to form a merged grammar tree and use the merged grammar tree to identify the individual grammar rules that match the search query. By checking the search query against the merged grammar tree instead of the individual grammar trees, the search system can eliminate unnecessary checks.

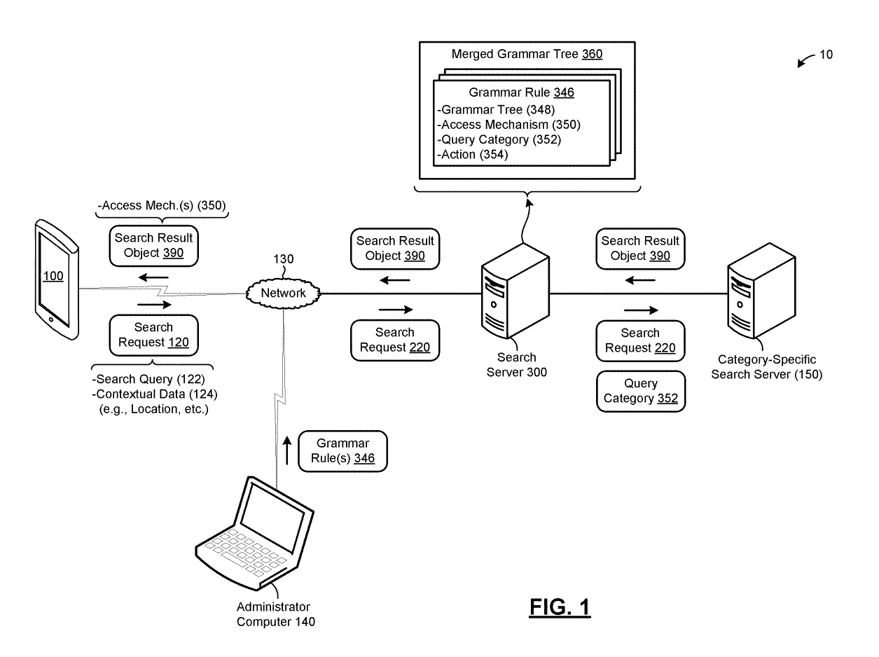

FIG. 1 illustrates an example system 10 that may be used to provide search results for search queries. The system 10 includes a mobile computing device 100 and a search server 300. The mobile computing device 100 and the search server 300 may communicate via a network 130. In general, the mobile computing device 100 sends a search request 120 to the search server 300. The search request 120 includes a search query 122. The search request 120 may also include contextual data 124 (e.g., location, time of day, etc.). The search server 300 receives the search request 120 and determines search results for the search query 122. Upon determining the search results, the search server 300 generates a search result object 390 to communicate the search results to the mobile computing device 100.

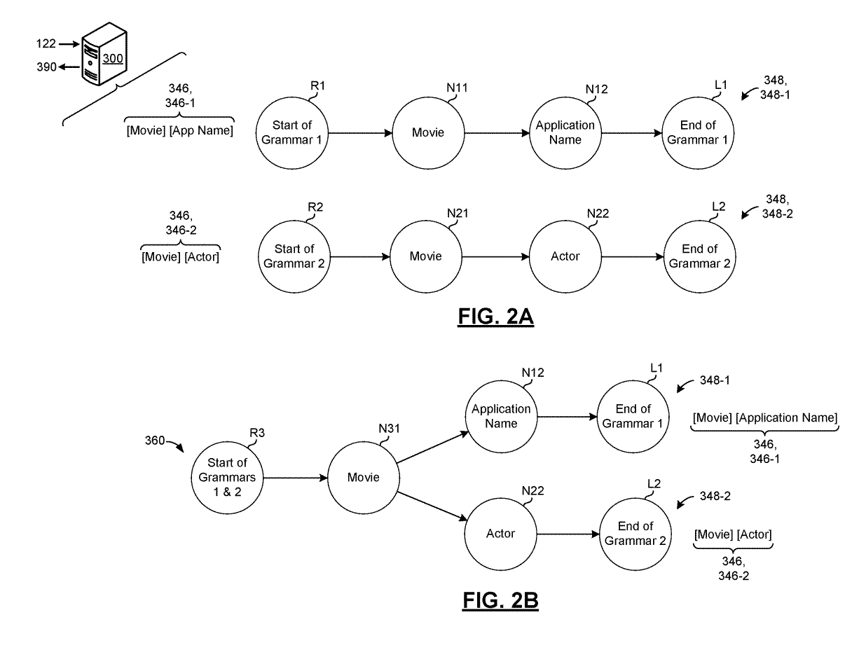

The system 10 may include an administrator computer 140 that can be used to configure the search server 300. For example, an administrator of the search server 300 may use the administrator computer 140 to send various grammar rules 346 to the search server 300. The search server 300 can receive and store the grammar rules 346. Each grammar rule 346 can define a set of entity types. An entity type may refer to a category of logical or physical objects. Examples of entity types are movies, restaurants, points of interest, etc. Some grammar rules 346 may include intent words that are associated with an entity type (e.g., “movie” and “watch” are intent words for the movie entity type). Some grammar rules 346 may include modifier words that refer to a subset of entities within a particular set of entities (e.g., “old” in “old movies” may refer to movies that are more than 20 years old). See FIG. 2A for example grammar rules 346.

The search server 300 can use the grammar rules 346 to determine the search results. For example, each grammar rule 346 may be associated with an access mechanism 350. The access mechanism 350 may include a string that identifies an application and can be used to access an application. The search server 300 can determine whether the search query 122 satisfies any of the grammar rules 346. If the search query 122 satisfies a particular grammar rule 346, the search server 300 can select the access mechanism 350 associated with that particular grammar rule 346 as a search result. The search server 300 can determine whether the search query 122 satisfies a particular grammar rule 346 by determining whether the search query 122 includes the entity types, intent words, and modifier words included in the grammar rule 346. If the search query 122 includes the entity types, intent words, and modifier words defined by a grammar rule 346, then the search query 122 satisfies the grammar rule 346. However, if the search query 122 does not include one or more entity types, intent words, or modifier words defined by a grammar rule 346, then the search query 122 does not satisfy the grammar rule 346.

The search server 300 can represent each grammar rule 346 as a grammar tree 348. A grammar tree 348 may include various tree nodes. Each tree node may represent an entity type, an intent word, or a modifier word. See FIG. 2A for example grammar trees 348. To avoid checking overlapping portions of grammar rules 346 multiple times, the search server 300 can merge the grammar trees 348 to form a merged grammar tree 360. See FIG. 2B for an example merged grammar tree 360 that can be formed by merging the grammar trees 348 shown in FIG. 2A. The search server 300 can utilize the merged grammar tree 360 to identify the grammar rules 346 that the search query 122 satisfies. Upon identifying the grammar rules 346 that the search query 122 satisfies, the search server 300 can select the access mechanisms 350 associated with the grammar rules 346 as search results.

In some implementations, each grammar rule 346 may be associated with a query category 352. The search server 300 can utilize the merged grammar tree 360 to identify a grammar rule 346 that matches the search query. Upon identifying a particular grammar rule 346 that matches the search query 122, the search server 300 can select the query category 352 associated with that particular grammar rule 346. The search server 300 can send the search request 120 to a category-specific search server 150 that provides search results for the selected query category 352. The category-specific search server 150 may be configured to provide search results for queries in that particular query category 352. For example, the category-specific search server 150 may be configured to provide search results for queries that are in a movies category, a cuisine category, a restaurant category, a travel category, etc. In response to sending the search request 120 to the category-specific search server 150, the search server 300 can receive the search result object 390 from the category-specific search server 150.

In some implementations, each grammar rule 346 may be associated with an action 354 that the search server 300 can perform. An action 354 may refer to a set of computer-readable instructions that the search server 300 can execute. In some examples, the action 354 may be to categorize the search query 122 into the query category 352 associated with the grammar rule 346. In some examples, the action 354 may be to select the access mechanism 350 associated with the grammar rule 346 as a search result. The action 354 can include various other operations.

FIG. 2A illustrates example grammar rules 346 and their corresponding grammar trees 348. In the example of FIG. 2A, a first grammar rule 346-1 defines a set of entity types that includes a movie entity and an application entity. In order to satisfy the first grammar rule 346-1, the search query 122 must include a movie name and an application name. If the search query 122 does not include a movie name and an application name, then the search query 122 does not satisfy the first grammar rule 346-1. As shown above in Table 1, the first grammar rule 346-1 may be associated with the application specified in the search query 122. If the search query 122 satisfies the first grammar rule 346-1, the search server 300 can select the application mechanism for the application specified in the search query 122 as a search result.

In the example of FIG. 2A, a second grammar rule 346-2 defines a set of entity types that includes a movie entity and an actor entity. In order to satisfy the second grammar rule 346-2, the search query 122 must include a movie name and an actor name. If the search query 122 does not include a movie name and an actor name, then the search query 122 does not satisfy the second grammar rule 346-2. As shown above in Table 1, the second grammar rule 346-2 may be associated with a particular movie application (e.g., the IMDB® movie database application). If the search query 122 satisfies the second grammar rule 346-2, the search server 300 can select the access mechanism for that particular movie application associated with the second grammar rule 346-2 as a search result.

The search server 300 can represent the first grammar rule 346-1 as a first grammar tree 348-1. The first grammar tree 348-1 can include a root node R1 that represents a starting point for the first grammar rule 346-1. The first grammar tree 348-1 can include a leaf node L1 that represents an end point for the first grammar rule 346-1. The first grammar tree 348-1 can include other nodes that represent the entity types, intent words, or modifier words specified in the first grammar rule 346-1. For example, the first grammar tree 348-1 can include a node N11 for the movie entity and a node N12 for the application entity. To determine whether the search query 122 satisfies the first grammar rule 346-1, the search server 300 may traverse the first grammar tree 348-1 starting from the root node R1. If the search query 122 includes all the entity types, intent words, and modifier words represented by the nodes between the root node R1 and the leaf node L1, then the search query 122 satisfies the first grammar rule 346-1.

Similarly, the search server 300 can generate a second grammar tree 348-2 to represent the second grammar rule 346-2. The second grammar tree 348-2 can include a root node R2 that represents a starting point for the second grammar rule 346-2 and a leaf node L2 that represents an end point for the second grammar rule 346-2. The second grammar tree 348-2 can include a node N21 for the movie entity and a node N22 for the actor entity. The search server 300 can traverse the second grammar tree 348-2 to determine whether the search query 122 satisfies the second grammar rule 346-2. If the search query 122 includes all the entity types represented by the nodes N21, N22, then the search query 122 satisfies the second grammar rule 346-2.

As illustrated in FIG. 2A, the nodes N11, N21 are identical because both the first grammar rule 346-1 and the second grammar rule 346-2 require the search query 122 to include a movie entity. By traversing identical nodes N11, N21, the search server 300 is effectively traversing the same node multiple times. Traversing identical nodes N11, N21 results in a waste of computing resources and may unnecessarily increase the amount of time required to perform the search. To eliminate traversing identical nodes N11, N21, the search server 300 can merge the grammar trees 348-1, 348-2 to form a merged grammar tree 360 (as shown in FIG. 2B).

In the example of FIG. 2B, the merged grammar tree 360 includes a root node R3 that represents a starting point for both the first grammar rule 346-1 and the second grammar rule 346-2. The merged grammar tree 360 includes the leaf nodes L1, L2 from the first grammar tree 348-1 and the second grammar tree 348-2, respectively. The merged grammar tree 360 includes other nodes from the first grammar tree 348-1 and the second grammar tree 348-2. For example, the merged grammar tree 360 includes the node N12 for the application entity in the first grammar rule 346-1 and the node N22 for the actor entity in the second grammar rule 346-2. The merged grammar tree 360 merges (e.g., combines) nodes that are identical. For example, the merged grammar tree 360 merged the identical nodes N11 and N21 into a single node N31.

By merging identical nodes, the search server 300 can reduce the amount of time required to perform a search. Referring to the example of FIG. 2B, the search server 300 can determine whether the search query 122 satisfies the first grammar rule 346-1 and/or the second grammar rule 346-2 by traversing the merged grammar tree 360. For example, if the search query 122 includes all the entity types, intent words, and modifier words represented by the nodes between the root node R3 and the leaf node L1, then the search query 122 satisfies the first grammar rule 346-1. Similarly, if the search query 122 includes all the entity types, intent words, and modifier words represented by the nodes between the root node R3 and the leaf node L2, then the search query 122 satisfies the second grammar rule 346-2. The benefit of using the merged grammar tree 360 is that the search server 300 only needs to check the search query 122 for the movie entity once instead of twice. For example, once the search server 300 traverses the node N31 in the merged grammar tree 360, the search server 300 has effectively traversed both nodes N11, N21 in the first grammar tree 348-1 and the second grammar tree 348-2, respectively.

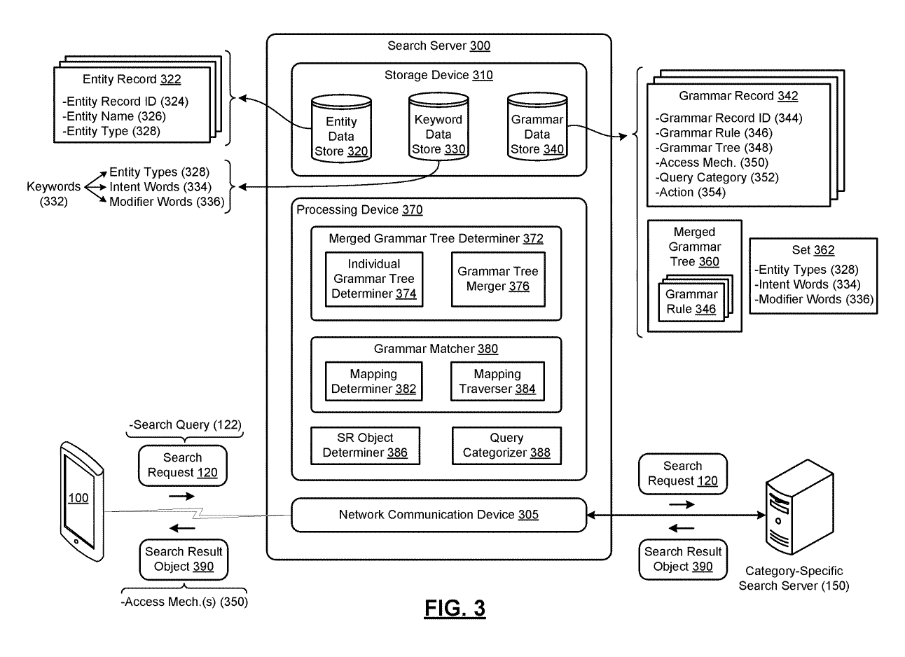

FIG. 3 is an example block diagram of the search server 300. The search server 300 may include a network communication device 305, a storage device 310, and a processing device 370. The search server 300 may be implemented by a cloud computing platform. The cloud computing platform may include a collection of remote computing services. The cloud computing platform may include computing resources (e.g., the processing device 370). The computing resources may include physical servers that have physical central processing units (pCPUs). The cloud computing resources may include storage resources (e.g., the storage device 310). The storage resources may include database servers that support NoSQL, MySQL, Oracle, SQL Server, or the like. The cloud computing platform may include networking resources (e.g. the network communication device 305). Example cloud computing platforms include Amazon Web Services®, Google Cloud Platform®, Microsoft AZURE™ and Alibaba Aliyun™.

The network communication device 305 communicates with a network (e.g., the network 130 shown in FIG. 1). The network communication device 305 may include a communication interface that performs wired communication (e.g., via Ethernet, Universal Serial Bus (USB) or fiber-optic cables). The network communication device 305 may perform wireless communication (e.g., via Wi-Fi, Bluetooth, Bluetooth Low Energy (BLE), Near Field Communications (NFC), ZigBee, a cellular network, or satellites). The network communication device 305 may include a transceiver. The transceiver may operate in accordance with an Institute of Electrical and Electronics Engineers (IEEE) specification (e.g., IEEE 802.3 or IEEE 802.11). The transceiver may operate in accordance with a 3rd Generation Partnership Project (3GPP) specification (e.g., Code Division Multiple Access (CDMA), Long Term Evolution (LTE) or LTE-Advanced). Advanced). The transceiver may operate in accordance with a Universal Serial Bus (USB) specification (e.g., via a USB port).

The storage device 310 stores data. The storage device 310 may include one or more computer readable storage mediums. For example, the storage device 310 may include solid state memory devices, hard disk memory devices, optical disk drives, read-only memory, etc. The storage device 310 may be connected to the processing device 370 via a bus and/or a network. Different storage mediums within the storage device 310 may be located at the same physical location (e.g., in the same data center, same rack, or same housing). Different storage mediums of the storage device 310 may be distributed (e.g., in different data centers, different racks, or different housings). The storage device 310 may implement (e.g., store) an entity data store 320, a keyword data store 330 and a grammar data store 340.

The entity data store 320 stores entity records 322. Each entity record 322 corresponds with an entity. An entity may refer to any physical or logical object. Example entities include movies, songs, restaurants, points of interest, etc. Each entity record 322 may include an entity record ID 324. The entity record ID 324 may include an alphanumeric string that identifies the entity record ID 324. An entity record 322 may include an entity name 326. The entity name 326 may refer to a name of the entity. For example, if the entity record 322 is for The Dark Knight movie, then the entity name 326 may be “The Dark Knight.” An entity record 322 may include an entity type 328. The entity type 328 may refer to a category of entities. For example, if the entity record 322 is for The Dark Knight movie, then the entity type 328 may be movie. Other example entity types 328 include person, point of interest, restaurant, etc. The entity data store 320 may include one or more databases, indices (e.g., inverted indices), tables, Look-Up Tables (LUT), files, or other data structures.

The keyword data store 330 can be used to identify entity types 328, intent words 334, and modifier words 336 in a grammar rule 346. The keyword data store 330 may store keywords 332 and each keyword 332 may be associated with an entity type 328, intent word 334, or modifier word 336. For example, the keyword “movie name” may be associated with a movie entity type. If a particular grammar rule 346 specifies “movie name,” then the search server 300 determines that the grammar rule 346 requires a movie entity. Similarly, the keyword “actor name” may be associated with a person entity type or actor entity type. If a particular grammar rule 346 specifies “actor name,” then the search server 300 determines that the grammar rule 346 requires an actor entity. Some keywords 332 can be characterized as an intent word 334. An intent word 334 may refer to words or phrases that are associated with an entity type. For example, “movie” and “watch” are intent words for movies. Some keywords 332 can be characterized as modifier words 336. A modifier word 336 may refer to words or phrases that refer to a subset of entities within a set of entities. For example, “old” in “old movies” may refer to movies that are more than 20 years old. A keyword 332 may refer to a string of characters. A keyword 332 can include multiple words.

The keyword data store 330 can receive a text string and determine whether the text string matches any of the keywords 332 stored in the keyword data store 330. If the text string matches a keyword 332 and the matching keyword 332 is associated with an entity type 328, then the keyword data store 330 can provide an indication that the text string is associated with the entity type 328. If the matching keyword 332 is an intent word 334, then the keyword data store 330 can provide an indication that the text string is an intent word 334. Similarly, if the matching keyword 332 is a modifier word 336, then the keyword data store 330 can provide an indication that the text string is a modifier word 336. The keyword data store 330 can utilize any suitable data structure to store the keywords 332 and their associated entity types 328. For example, the keyword data store 330 may include one or more databases, indices (e.g., inverted indices), tables, Look-Up Tables (LUT), files, or other data structures.

The grammar data store 340 stores grammar records 342. Each grammar record 342 includes a grammar record ID 344. The grammar record ID 344 may include an alphanumeric string that identifies the grammar record 342. Each grammar record 342 corresponds with a grammar rule 346. Each grammar rule 346 may define a set of entity types 328. Some grammar rules 346 may include intent words 334 that are associated with an entity type (e.g., “movie” and “watch” are intent words for the movie entity type). Some grammar rules 346 may include modifier words 336 that refer to a subset of entities within a particular set of entities (e.g., “old” in “old movies” may refer to movies that are more than 20 years old). See FIG. 2A for example grammar rules 346.

A grammar record 342 may store a grammar tree 348. The grammar tree 348 may be a graphical representation of the grammar rule 346. The grammar tree 348 may resemble a tree data structure. For example, the grammar tree 348 may include a root node that represents a starting point for the grammar rule 346, a leaf node that represents an end point for the grammar rule 346, and intermediate nodes that represent the entity types 328, intent words 334, and modifier words 336 in the grammar rule 346. The search server 300 can generate the grammar tree 348 based on the grammar rule 346. Alternatively, the search server 300 may receive the grammar tree 348 (e.g., from the administrator computer 140 shown in FIG. 1). The grammar records 342 may store the grammar trees 348 in addition to the grammar rules 346 or as an alternative to the grammar rules 346.

A grammar record 342 can store information that is associated with a grammar rule 346. For example, a grammar record 342 may store an access mechanism 350. The access mechanism 350 may include a string that identifies an application and can be used to access an application. The access mechanism 350 may include a URL that may be referred to as an application URL or an access URL. In some scenarios, the access mechanism 350 may point to a particular state of the application (e.g., a state that is different from a default state of the application). An access mechanism 350 that points to a particular state of the application may be referred to as a state access mechanism. Upon determining that the search query 122 satisfies a grammar rule 346, the search server 300 can transmit the access mechanism 350 associated with the grammar rule 346 as a search result.

A grammar record 342 may store a query category 352. The query category 352 may be associated with the grammar rule 346. A query category 352 may be referred to as a ‘vertical’. Upon determining that the search query 122 satisfies a particular grammar rule 346, the search server 300 can categorize the search query 122 into the query category 352 associated with that particular grammar rule 346. Referring to FIG. 2B, upon determining that the search query 122 satisfies the first grammar rule 346-1, the search server 300 can categorize the search query 122 as a movie query. The search server 300 may categorize some search queries 122 into multiple query categories 352. For example, a search query 122 that includes the search terms “The Dark Knight” may satisfy a first grammar rule 346 that is associated with a movie category and a second grammar rule 346 that is associated with a comic book category. Other example query categories 352 for the search query 122 include a restaurant query, a cuisine query, a travel query, a hotel query, etc.

A grammar record 342 may store an action 354 that is associated with the grammar rule 346. An action 354 may refer to a set of computer-readable instructions that the search server 300 can execute if the search query 122 satisfies the grammar rule 346. In some implementations, the action 354 may be to select the access mechanism 350 as a search result and transmit the access mechanism 350 to the mobile computing device 100. In some implementations, the action 354 may be to categorize the search query 122 into the query category 352 associated with the grammar rule 346 and transmit the search query 122 to a category-specific search server 150. For example, if the query category 352 indicates that the search query 122 is a travel-related search query, then the search server 300 can transmit the search query 122 to a category-specific search server 130 that is configured to provide search results for travel-related search queries.

The grammar data store 340 can also store a merged grammar tree 360. The search server 300 may generate (e.g., determine) the merged grammar tree 360 by merging (e.g., combining) the individual grammar trees 348. Consequently, the merged grammar tree 360 may be considered a graphical representation of all the grammar rules 346. Instead of traversing individual grammar trees 348, the search server 300 can traverse the merged grammar tree 360 to determine which grammar rules 346 the search query 122 satisfies.

The processing device 370 may include a collection of one or more computing processors that execute computer-readable instructions. The computing processors of the processing device 370 may operate independently or in a distributed manner. The computing processors may be connected via a bus and/or a network. The computing processors may be located in the same physical device (e.g., same housing). The computing processors may be located in different physical devices (e.g., different housings, for example, in a distributed computing system). A computing processor may include physical central processing units (pCPUs). A pCPU may execute computer-readable instructions to implement virtual central processing units (vCPUs). The processing device 370 may execute computer-readable instructions corresponding with a merged grammar tree determiner 372 and a grammar matcher 380. The processing device 370 may also execute computer-readable instructions for a search results object determiner 386 and/or a query categorizer 388.

The merged grammar tree determiner 372 determines (e.g., generates) the merged grammar tree 360. The merged grammar tree determiner 372 may generate an individual grammar tree 348 for each grammar rule 346. Upon generating the individual grammar trees 348, the merged grammar tree determiner 372 can merge (e.g., combine) the individual grammar trees 348 to form the merged grammar tree 360. The merged grammar tree determiner 372 can store the merged grammar tree 360 in the grammar data store 340. The merged grammar tree determiner 372 may include an individual grammar tree determiner 374 that generates the individual grammar trees 348 and a grammar tree merger 376 that merges the individual grammar trees 348 to form the merged grammar tree 360.

The individual grammar tree determiner 374 generates a grammar tree 348 for each grammar rule 346. To generate a grammar tree 348 for a grammar rule 346, the individual grammar tree determiner 374 can start by identifying entity types 328, intent words 334, and modifier words 336 in a grammar rule 346. The individual grammar tree determiner 374 can utilize the keyword data store 330 to identify the entity types 328, intent words 334, and modifier words 336 specified in a grammar rule 346. Specifically, the individual grammar tree determiner 374 can query the keyword data store 330 with a grammar rule 346 and receive the entity types 328 that the grammar rule 346 specifies. In some implementations, the individual grammar tree determiner 374 can tokenize a grammar rule 346, form n-grams from the tokens, and query the keyword data store 330 with the n-grams. In response to the query, the individual grammar tree determiner 374 may receive the entity types 328 associated with the n-grams. Additionally, the individual grammar tree determiner 374 may receive an indication that certain n-grams are intent words 334 or modifier words 336.

Upon identifying the entity types 328, intent words 334, and modifier words 336 specified by a grammar rule 346, the individual grammar tree determiner 374 can use any suitable technique to generate the grammar tree 348 for the grammar rule 346. For example, the individual grammar tree determiner 374 may use any tree drawing algorithm to generate the grammar tree 348. In some implementations, the individual grammar tree determiner 374 can instantiate a tree data structure. For each entity type 328, intent word 334, and modifier word 336 in the grammar rule 346, the individual grammar tree determiner 374 can instantiate a tree node. In other words, each tree node represents an entity type 328, an intent word 334, or a modifier word 336 specified by the grammar rule 346. The individual grammar tree determiner 374 connects the tree nodes with tree edges to form a grammar tree 348 for the grammar rule 346. If the grammar rule 346 specifies a particular sequence for the entity types 328, intent words 334, and modifiers words 336, then the individual grammar tree determiner 374 connects the tree nodes to represent that particular sequence. For example, if a grammar rule 346 specifies that a [movie name] must appear immediately before an [actor name], then the node representing the movie entity is a parent of the node representing the actor entity. Each grammar tree 348 may include a root node that represents a starting point for the grammar rule 346 and a leaf node that represents an end point for the grammar rule 346.

The grammar tree merger 376 merges (e.g., combines) the individual grammar trees 348 to form a merged grammar tree 360. The merged grammar tree 360 may be considered a graphical representation of all the grammar rules 346 stored in the grammar data store 340. The grammar tree merger 376 may use any suitable technique to merge the grammar trees 348. In some implementations, the grammar tree merger 376 selects a first grammar tree 348 as a starting point to generate the merged grammar tree 360. The first grammar tree 348 may be the largest grammar tree 348. Upon selecting the first grammar tree 348 as a starting point for the merged grammar tree 360, the grammar tree merger 376 can append other grammar trees 348 to the root node of the first grammar tree 348 in order to transform the first grammar tree 348 into the merged grammar tree 360.

The grammar tree merger 376 can determine a size for each of the grammar trees 346. The size of a grammar tree 348 may refer to a quantifiable characteristic of the grammar tree 348. For example, the size of a grammar tree 348 may refer to the number of nodes in the grammar tree 348. Alternatively or additionally, the size of a grammar tree 348 can refer to the number of levels in the grammar tree 348. The size of a grammar tree 348 can also refer to the number of edges in the grammar tree 348. Upon determining the size for each of the grammar trees 346, the grammar tree merger 376 can select the first grammar tree 348 by selecting the grammar tree 348 associated with the largest size. For example, the first grammar tree 348 may be the grammar tree 348 with the highest number of nodes.

Upon selecting the first grammar tree 348, the grammar tree merger 376 can select a second grammar tree 348 to merge with the first grammar tree 348. The grammar tree merger 376 may select the second largest grammar tree 348 as the second grammar tree 348. Alternatively, the grammar tree merger 376 may select the smallest grammar tree 348 as the second grammar tree 348. The grammar tree merger 376 can also select the second grammar tree 348 randomly (e.g., pseudo-randomly). In some implementations, the grammar tree merger 376 selects the second grammar tree 348 such that a first root node of the first grammar tree 348 and a second root node of the second grammar tree 348 are identical.

The grammar tree merger 376 merges the first grammar tree 348 and the second grammar tree 348. The grammar tree merger 376 can use any suitable technique for merging the first grammar tree 348 and the second grammar tree 348. In some implementations, the grammar tree merger 376 can determine whether the first root node of the first grammar tree 348 and the second root node of the second grammar tree 348 are identical. If the first root node and the second root node are identical, then the grammar tree merger 376 can purge the second root node and append the remainder of the second grammar tree 348 to the first root node of the first grammar tree 348 to form the merged grammar tree 360. The grammar tree merger 376 can continue merging other grammar trees 348 into the merged grammar tree 360 until all the grammar trees 348 have been merged into the merged grammar tree 360.

The grammar tree merger 376 can optimize the merged grammar tree 360 by removing (e.g., purging) duplicate nodes on the same level. Optimizing the merged grammar tree 360 may be referred to as trimming or pruning the merged grammar tree 360. The grammar tree merger 376 may use any suitable technique for optimizing the merged grammar tree 360. In some implementations, the grammar tree merger 376 can start traversing the merged grammar tree 360 at its root node and remove identical nodes from every level of the merged grammar tree 360. For example, the grammar tree merger 376 can identify child nodes of the root node of the merged grammar tree 360. Upon identifying the child nodes, the grammar tree merger 376 can determine whether any of the child nodes are identical. A first child node may be identical to a second child node if the first child node and the second node represent the same entity type 328, intent word 334, or modifier word 336. If the first child node and the second child node are identical, then the grammar tree merger 376 can purge the second child node and append any nodes that descend from the second child node to the first child node. In other words, descendant nodes of the node that is being purged become descendant nodes of the node that is not being purged.

The grammar tree merger 376 can continue optimizing the merged grammar tree 360 until there are no identical nodes on any given level of the merged grammar tree 360. The grammar tree merger 376 can use various other techniques to optimize the merged grammar tree 360. As illustrated in FIG. 2B, the merged grammar tree 360 can include a root node that represents a starting point for all the grammar rules 346. The merged grammar tree 360 can also include numerous leaf nodes that represent end points for different grammar rules 346.

The merged grammar tree determiner 372 can determine a set 362 of entity types 328, intent words 334, and modifier words 336 that the search query 122 should include in order utilize the merged grammar tree 360 for grammar matching. In some implementations, the set 362 includes the entity types 328, intent words 334, and modifier words 336 that the search query 122 should include in order to satisfy at least one grammar rule 346. The merged grammar tree determiner 372 can determine the set 362 by identifying the grammar rule 346 with the fewest number of entity types 328, intent words 334, and modifier words 336. Alternatively, the merged grammar tree determiner 372 can determine the shortest path from the root node of the merged grammar tree 360 to any leaf node that represents the end point of a grammar rule 346. Upon determining the shortest path, the merged grammar tree determiner 372 can identify the entity types 328, intent words 334, and modifier words 336 that correspond with the nodes on the shortest path. In some implementations, the set 362 includes entity types 328, intent words 334, and/or modifier words 336 that are common to all the grammar rules 346. The merged grammar tree determiner 372 may determine the intersection of all the grammar rules 346. If the intersection of all the grammar rules 346 is not null, then the merged grammar tree determiner 372 can instantiate a list and write all the entity types 328, intent words 334, and modifier words 336 from the intersection into the list.

The merged grammar tree determiner 372 stores the set 362 in association with the merged grammar tree 360. In some implementations, the merged grammar tree determiner 372 can instantiate a data container (e.g., a list, a file, or any other data structure). Upon instantiating the data container, the merged grammar tree determiner 372 can write the entity types 328, the intent words 334, and the modifier words 336 from the set 362 into the data container. After writing the information from the set 362 to the data container, the merged grammar tree determiner 372 can store the data container in association with the merged grammar tree 360. For example, the merged grammar tree determiner 372 can store the data container in the grammar data store 340.

The grammar matcher 380 determines whether the search query 122 matches any of the grammar rules 346. The grammar matcher 380 can utilize the merged grammar tree 360 to determine whether the search query 122 matches any of the grammar rules 346. The grammar matcher 380 may include a mapping determiner 382 that generates a mapping of the entity types 328 and their token start positions to their token end positions. The grammar matcher 380 may also include a mapping traverser 384 that uses (e.g., traverses) the mapping to identify the grammar rules 346 that the search query 122 satisfies.

The mapping determiner 382 may include a query analyzer (not shown) that analyzes the search query 122. The search query 122 may include one or more search terms. The query analyzer can tokenize the search query 122 by identifying parsed tokens. The query analyzer may perform stemming by reducing words in the search query to their stem word or root word. The query analyzer can perform synonymization by identifying synonyms of search terms in the search query. The query analyzer can also perform stop word removal by removing commonly occurring words from the search query (e.g., by removing “the”, “a”, etc.).

The query analyzer can use the tokens to generate n-grams. An n-gram may include one or more tokens. An n-gram that includes only one token may be referred to as a unigram. An n-gram that includes two tokens may be referred to as a bigram. The query analyzer can generate n-grams by grouping sequential tokens. In other words, the query analyzer can generate n-grams by grouping tokens that appear in a sequence. For example, if the search query 122 is “The Dark Knight Christian Bale,” then the query analyzer may generate the following unigrams: “The,” “Dark,” “Knight,” “Christian,” and “Bale.” Similarly, the query analyzer may generate the following bigrams: “The Dark,” “Dark Knight,” “Knight Christian,” and “Christian Bale.” Furthermore, the query analyzer 382 can generate the following trigrams: “The Dark Knight,” “Dark Knight Christian,” and “Knight Christian Bale.” Moreover, the query analyzer 382 can generate the following 4-grams: “The Dark Knight Christian” and “Dark Knight Christian Bale.” Lastly, the query analyzer can generate the following 5-gram: “The Dark Knight Christian Bale.”

The query analyzer can identify the entity types 328 associated with the n-grams. The query analyzer can query the entity data store 320 with the n-grams and receive the entity types 328 of the n-grams. For example, one of the n-grams may include the words “The Dark Knight.” Upon querying the entity data store 320 with “The Dark Knight,” the query analyzer can receive an indication that “The Dark Knight” is a movie entity. The query analyzer can also determine whether an n-gram is an intent word 334 or a modifier word 336. To determine whether an n-gram is an intent word 334 or a modifier word 336, the query analyzer can query the keyword data store 330 with the n-gram. If the n-gram is an intent word 334 or a modifier word 336, then the query analyzer can receive an indication that the n-gram is an intent word 334 or a modifier word 336. Table 2 illustrates an example search query 122 and the entity types 328 that the query analyzer identified for the search query 122. In the example of Table 2, the search query 122 is “The Dark Knight Christian Bale.”

TABLE 2
Example Search Query with Entity Types

| 0 | 1 | 2 | 3 | 4 |
|---|---|---|---|---|
| The | Dark | Knight | Christian | Bale |

| | |
|---|---|
| Movie (0, 2) | Actor (3, 4) |

The mapping determiner 382 can generate a first mapping mechanism that maps a token start position and a token end position to an entity type 328, an intent word 334, or a modifier word 336. The first mapping mechanism may be referred to as a chart parse. The mapping determiner 382 can use various techniques to generate the first mapping mechanism. In some implementations, the mapping determiner 382 can generate the first mapping mechanism by using the Viterbi algorithm or any variant of the Viterbi algorithm. Alternatively, the mapping determiner 382 can generate the first mapping mechanism by using any technique associated with the Earley parser. Moreover, the mapping determiner 382 can generate the first mapping mechanism by using the Cocke-Younger-Kasami (CYK) algorithm or a variant of the CYK algorithm. Table 3 shows an example of the first mapping mechanism. In the example of Table 3, the first mapping mechanism is for “The Dark Knight Christian Bale” query.

TABLE 3
First Mapping Mechanism (e.g., Chart Parse) maps Token
Start Position and Token End Position to Entity
Type, Intent Word, or Modifier Word

| (Start Position, End | Entity Type, Intent |
|---|---|
| Position) | Word or Modifier Word |
| (0, 2) | Movie |
| (3, 4) | Actor |

The first mapping mechanism can be represented as a function that receives a token start position and a token end position as inputs and outputs an entity type 328, intent word 334, or modifier word 336 that spans from the token start position to the token end position. Equation 1 illustrates a mathematical representation of the first mapping mechanism as a function.

f₁(x,y)→Entity Type, Intent Word or Modifier Word (1)
where x=token start position; and y=token end position

The mapping determiner 382 can generate a second mapping mechanism that maps entity types 328, intent words 334, or modifier words 336 to a token start position and a token end position. The mapping determiner 382 can generate the second mapping mechanism by inverting the first mapping mechanism. Consequently, the second mapping mechanism may be referred to as an inverse of the first mapping mechanism. If the first mapping mechanism is referred to as a chart parse, then the second mapping mechanism may be referred to as an inverse chart parse. Table 4 illustrates an example of the second mapping mechanism. In the example of Table 4, the second mapping mechanism is for “The Dark Knight Christian Bale” query.

TABLE 4
Second Mapping Mechanism (e.g., Inverse Chart
Parse) maps Entity Types, Intent Words and Modifier Words
to Token Start Position and Token End Position

| Entity Type, Intent Word | (Start Position, End |
|---|---|
| or Modifier Word | Position) |
| Movie | (0, 2) |
| Actor | (3, 4) |

The second mapping mechanism can be represented as a function that receives an entity type 328, an intent word 334, or a modifier word 336 as an input and outputs a token start position and a token end position. The token start position and the token end position represent a range of tokens throughout which the entity type 328, the intent word 334 or the modifier word 336 span. Equation 2 illustrates a mathematical representation of the second mapping mechanism as a function.

f₂(Entity Type, Intent Word or Modifier Word)→x, y (2)
where x=token start position; and y=token end position

The mapping determiner 382 can generate a third mapping mechanism that maps entity types 328, intent words 334, or modifier words 336, and a token start position to a token end position. The mapping determiner 382 can generate the third mapping mechanism by augmenting (e.g., transforming) the second mapping mechanism. If the second mapping mechanism is referred to as an inverse chart parse, then the third mapping mechanism may be referred to as an augmented inverse chart parse. Table 5 illustrates an example of the third mapping mechanism. In the example of Table 5, the third mapping mechanism is for “The Dark Knight Christian Bale” query.

TABLE 5
Third Mapping Mechanism (e.g., augmented inverse chart parse)
maps Entity Types, Intent Words or Modifier Words
and their Start Token Positions to their End Token Positions

| (Entity Type, Intent Word or Modifier | End |
|---|---|
| Word), Start Position | Position |
| Movie, 0 | 2 |
| Actor, 3 | 4 |

The third mapping mechanism can be represented as a function that receives an entity type 328, an intent word 334, or a modifier word 336 along with a token start position. The token start position represents a location within the search query 122 where the entity type 328, intent word 334, or modifier word 336 starts. The function outputs a token end position that represents a location within the search query 122 where the entity type 328, intent word 334, or modifier word 336 stops. Equation 3 illustrates a mathematical representation of the third mapping mechanism as a function.

f₃(Entity Type, Intent Word or Modifier Word, x)→y (3)
where x=token start position; and y=token end position

In some implementations, the mapping determiner 382 can generate the third mapping mechanism without explicitly generating the first mapping mechanism and the second mapping mechanism. In other words, the mapping determiner 382 may generate the augmented inverse chart parse without explicitly generating the chart parse and the inverse chart parse. If the mapping determiner 382 explicitly generates the first mapping mechanism and the second mapping mechanism, then the mapping determiner 382 can purge the first mapping mechanism and the second mapping mechanism upon generating the third mapping mechanism. The grammar matcher 380 can use the third mapping mechanism to determine the grammar rules 346 that the search query 122 satisfies. A benefit of using the third mapping mechanism is that the third mapping mechanism can be stored as a relatively compact data structure. Due to its compact nature, the third mapping mechanism requires relatively less memory to store. Hence, the third mapping mechanism can be stored in a cache of the processing device 370 instead of being stored in the storage device 310.

A benefit of using the third mapping mechanism is that generating the third mapping mechanism may be an O(n) operation, where n is the number of tokens in the search query 122. Another benefit of using the third mapping mechanism instead of the first mapping mechanism is that traversing the third mapping mechanism is approximately an O(depth x length) operation instead of an O(depth ̂ length) operation, where depth refers to the depth of the third mapping mechanism and length refers to the length of the search query 122. Depth of the third mapping mechanism refers to the average number of entity types associated with a token.

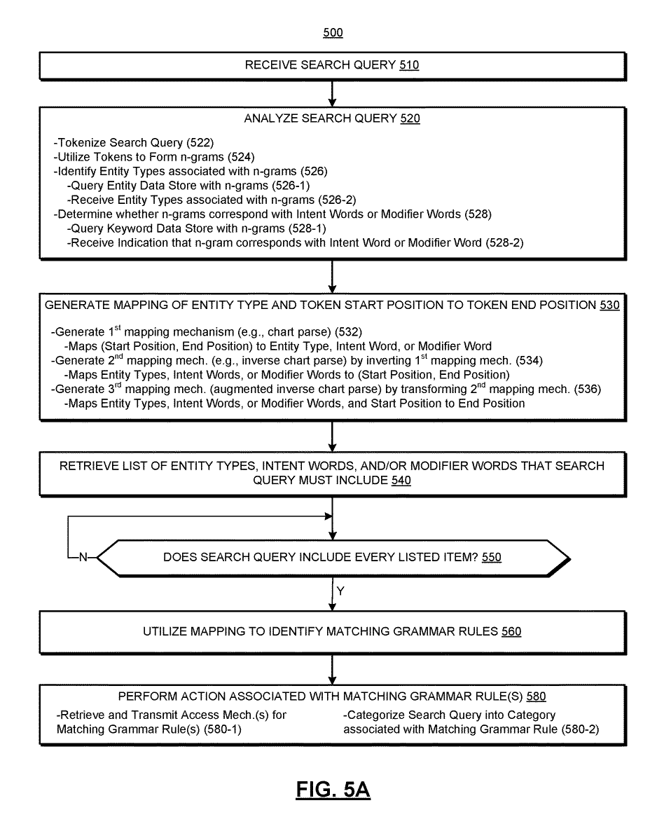

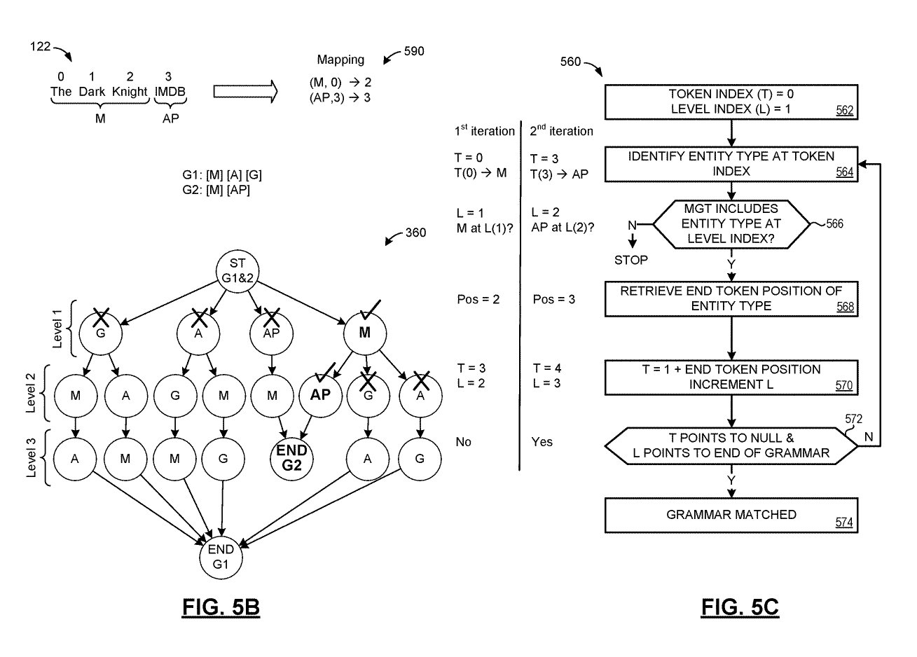

The mapping traverser 384 utilizes the mapping of entity types 328 and token start positions to token end positions to determine the grammar rules 346 that match the search query 122. Specifically, the mapping traverser 384 can utilize the third mapping mechanism to determine whether the search query 122 matches any of the grammar rules 346. In some implementations, before using the mapping, the mapping traverser 384 can determine whether the mapping includes the entity types 328, intent words 334, and modifier words 336 in the set 362. If the mapping does not include all the elements specified in the set 362, then the grammar matcher 380 can determine that the search query 122 does not match any of the grammar rules 346. However, if the search query 122 includes all the elements of the set 362, then the mapping traverser 384 can use the mapping to determine the grammar rules 346 that the search query 122 matches. See FIG. 5C for an example method that the mapping traverser 384 can execute to determine the grammar rules 346 that the search query 122 matches. Upon determining the grammar rules 346 that match the search query 122, the mapping traverser 384 can send the grammar record IDs 344 for the matching grammar rules 346 to the search result object determiner 386 and/or the query categorizer 388.

The search results object determiner 386 generates the search result object 390. The search result object 390 may include access mechanisms 350 that correspond with grammar rules 346 that match the search query 122. The search results object determiner 386 may receive grammar record IDs 344 for the matching grammar rules 346 from the mapping traverser 384. Upon receiving the grammar record IDs 344, the search results object determiner 386 can retrieve the access mechanisms 350 from the grammar records 342 identified by the grammar record IDs 344. The search results object determiner 386 can instantiate a data container that represents the search results object 390 and write the access mechanisms 350 to data container. The data container may be a JavaScript Object Notation (JSON) object, an Extensible Markup Language (XML) file, or the like.

The query categorizer 388 categorizes the search query 122 based on the grammar rule 346 that matches the search query 122. The query categorizer 388 can categorize the search query 122 into the query category 352 associated with the matching grammar rule 346. Upon categorizing the search query 122, the query categorizer 388 can send the search query 122 to a category-specific search server 150. For example, if the query category 352 is travel, then the query categorizer 388 can send the search query 122 to a category-specific search server 150 that processes travel-related search queries 122. Similarly, if the query category 352 is restaurant, then the query categorizer 388 can send the search query 122 to a category-specific search server 150 that processes restaurant or cuisine related search queries 122. Upon transmitting the search query 122 to the category-specific search server 150, the search server 300 may receive the search result object 390 from the category-specific search server 150. The search server 300 can transmit the search result object 390 to the mobile computing device 100 upon receiving the search result object 390 from the category-specific search server 150.

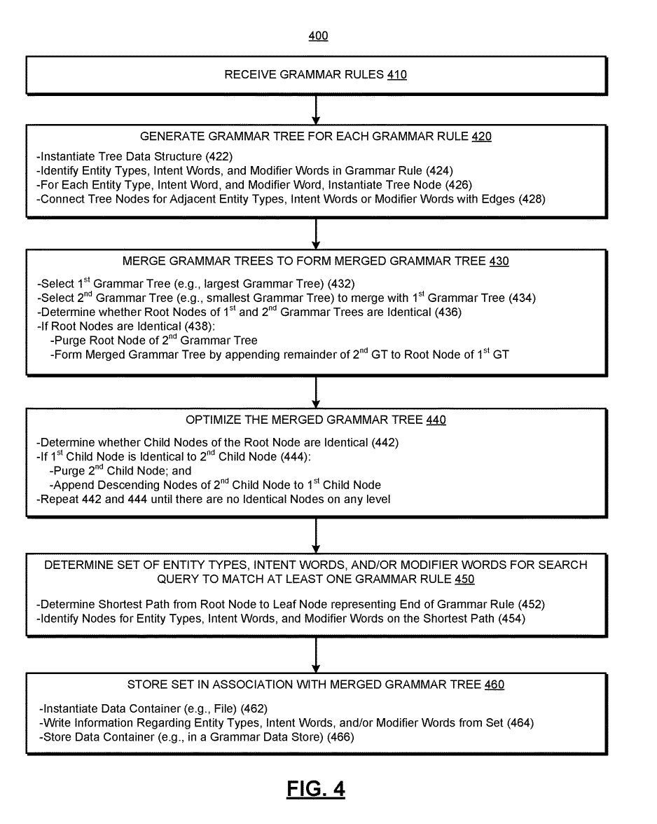

FIG. 4 illustrates an example method 400 for combining various grammar rules. The method 400 can be executed by a search server (e.g., the search server 300 shown in FIG. 3). The method 400 may be implemented as a set of computer-readable instructions that are executed by a processing device (e.g., the processing device 370 shown in FIG. 3). Generally, the search server receives grammar rules (at 410). The search server can combine the grammar rules. For example, the search server can generate a grammar tree for each grammar rule (at 420) and merge the individual grammar trees to form a merged grammar tree (at 430). The merged grammar tree may have duplicate nodes, so the search server can optimize the merged grammar tree by purging the duplicate nodes (at 440). Checking each grammar rule individually may result in a waste of computing resources because many grammar rules may overlap. By combining the grammar rules, the search server can conserve computing resources that would have been wasted in checking overlapping portions of the grammar rules.

To further conserve computing resources, the search server can determine a set of entity types that the search query must include (at 450). The set of entity types may represent the entity types that the search query should include to match at least one grammar rule. The search server can store the set of entity types as a list (at 460). The search server can use the list to avoid checking any grammar rules in the merged grammar tree. For example, the search server can determine whether the search query includes all the entity types specified in the list. If the search query does not include all the entity types specified in the list, then the search server can determine not to check any of the grammar rules. By performing a relatively quick check against the list, the search server can conserve computing resources that would have been wasted in checking for grammar rules.

Referring to 410, the search server receives grammar rules. The search server may receive the grammar rules from an administrator computer. For example, an administrator of the search server may use the administrator computer to input the grammar rules. Each grammar rule may specify one or more entity types. An entity type may refer to a category of physical or logical objects. Example entity types include movies, software applications, restaurants, etc. A grammar rule may also include one or more intent words. An intent word may refer to words or phrases that are associated with a particular entity type (e.g., “movie” and “watch” are intent words for movies). A grammar rule can also include one or more modifier words. A modifier word may refer to a subset of entities within a set of entities (e.g., “old” in “old movies” may refer to movies that are more than 20 years old). See Table 1 for example grammar rules. Each grammar rule may be associated with information that the search server can use to provide search results. For example, each grammar rule may be associated with an access mechanism or a query category. Upon receiving the grammar rules, the search server can store the grammar rules in a grammar data store.

The search server can use the grammar rules to provide search results. For example, when the search server receives a search query, the search server can identify the grammar rules that match the search query. Upon identifying grammar rules that match the search query, the search server can select access mechanisms associated with the matching grammar rules and transmit the access mechanisms as search results. The search query matches a grammar rule if the search query includes all the entity types, intent words, and modifier words specified in the grammar rule. Checking each grammar rule individually may result in a waste of computing resources because many grammar rules may overlap. Because many grammar rules may include a common set of entity types, checking for the set of entity types that are common to multiple grammar rules may result in a waste of computing resources. For example, two different grammar rules may include the movie entity. If each of the two grammar rules is checked individually, then the search server unnecessarily checks the search query for the movie entity twice. The search server can conserve computing resources by combining the grammar rules so that the search server does not have to check the search query for the presence of the common set of entity types multiple times. The search server can use various techniques to combine the grammar rules. In some implementations, the search server may perform the operations identified by blocks 420, 430, and 440 to combine the grammar rules.

Referring to 420, the search server can generate a grammar tree for each grammar rule. A grammar tree may refer to a graphical representation of the grammar rule. The search server can use various techniques to generate the grammar trees. In some implementations, the search server can generate the grammar tree by instantiating a tree data structure (at 422). The search server can use the tree data structure as a basis for building the grammar tree for the grammar rule. At 424, the search server can identify the entity types, intent words, and modifier words in the grammar rule. The search server may utilize the keyword data store 330 (shown in FIG. 3) to identify the entity types, intent words, and modifier words specified in the grammar rule. For example, the search server can tokenize the grammar rule and use the tokens to generate n-grams. The search server can query the keyword data store 330 with the n-grams. Upon querying the keyword data store 330 with the n-grams, the search server may receive entity types associated with the n-grams. The search server can also receive an indication indicating whether an n-gram is an intent word or a modifier word. Upon identifying the entity types, intent words, and modifier words in the grammar rule, the search server can instantiate a tree node for each of the entity types, intent words, and modifier words specified in the grammar rule (at 426). Lastly, the search server can connect the tree nodes for adjacent entity types with tree edges (at 428). The operations indicated by 422-428 illustrate an example technique for generating a grammar tree. The search server can use various other techniques to generate the grammar tree. For example, the search server can use any tree drawing technique for generating the grammar tree.

Referring to 430, upon generating a grammar tree for each grammar rule, the search server can merge the grammar trees to form a merged grammar tree. In some implementations, the search server selects a first grammar tree (at 432). After selecting the first grammar tree, the search server can select a second grammar tree to merge with the first grammar tree (at 434). At 436, the search server determines whether a first root node of the first grammar tree is identical to a second root node of the second grammar tree. If the first root node and the second root node are identical, then the search server purges the second root node and appends the remainder of the second grammar tree to the first root node to form the merged grammar tree (at 438). In some implementations, the root nodes of the grammar trees are always identical because the root nodes indicate the start of the grammar rule. For example, the root nodes may specify “Start.” The search server can further construct the merged grammar tree by merging additional grammar trees. For example, the search server can select a third grammar tree and repeat the operations indicated by 436-438 for the third grammar tree.

Referring to 432, the search server may select the first grammar tree by selecting the largest grammar tree. Similarly, referring to 434, the search server may select the second grammar tree by selecting the smallest grammar tree or the second largest grammar tree. Prior to selecting the first grammar tree and the second grammar tree, the search server can determine a size for each of the grammar trees. The search server can use various techniques to determine the size of a grammar tree. For example, the search server can determine the size of a grammar tree by determining the number of tree nodes in the grammar tree, the number of tree edges in the grammar tree, and/or the number of levels in the grammar tree.

At 440, the search server optimizes the merged grammar tree. The search server may determine to optimize the merged grammar tree because certain levels of the merged grammar tree may include duplicate nodes. For example, the merged grammar tree may include five movie nodes at the same level. In this example, the five movie nodes can be condensed into a single movie node. The search server can start optimizing the merged grammar tree from the root node of the merged grammar tree. For example, at 442, the search server determines whether child nodes of the root node are identical. If a first child node is identical to a second child node, then the search server can purge the second child node and append any nodes that descend from the second child node to the first child node (at 444). The search server can repeat the operations indicated by 442-444 for lower levels in the merged grammar tree. Optimizing the merged grammar tree may be referred to as trimming or pruning the merged grammar tree. The search server can use any other suitable techniques for optimizing the merged grammar tree.

At 450, the search server determines a set of entity types, intent words, and/or modifier words that a search query must include in order to perform grammar matching. The set of entity types, intent words, and/or modifier words may be common to all the grammar rules. Alternatively, the set of entity types, intent words, and/or modifier words may be required to satisfy at least one grammar rule. Put another way, the set includes the minimum number of entity types, intent words, and modifier words that the search query must include in order for the search server to perform grammar matching. In some implementations, the search server determines the shortest path from the root node of the merged grammar tree to any leaf node that represents the end of a grammar rule (at 452). The search server can use any suitable technique for determining the shortest path. For example, the search server may use Dijkstra's algorithm or a variant of the Dijkstra's algorithm for determining the shortest path. Upon determining the shortest path, the search server can identify all the entity types, intent words, and modifier words on the shortest path (at 454).

At 460, the search server stores the set of entity types, intent words, and modifier words on the shortest path. At 462, the search server can instantiate a data container (e.g., a list, a file, etc.). Upon instantiating the data container, the search server can write information regarding the set of entity types, intent words, and modifier words to the data container (at 464). At 466, the search server can store the data container. The search server may store the data container in association with the merged grammar tree. For example, the search server may store the data container in the grammar data store 340 shown in FIG. 3.

In some implementations, the search server may perform the operations indicated by 450, 460 for subtrees of the merged grammar tree. The search server may identify several subtrees within the merged grammar tree. For each subtree, the search server can determine a minimum set of entity types that the search query should include for the search server to traverse the subtree. Before traversing that particular subtree, the search server can determine whether the search query includes the minimum set of entity types. If the search query does not include the minimum set of entity types, then the search server may not traverse the subtree. However, if the search query includes the minimum set of entity types, then the search server can traverse the subtree. The search server can determine the minimum set of entity types for a subtree by determining the shortest path from the root node of the subtree to a leaf node that represents the end of a grammar rule.

FIG. 5A illustrates an example method 500 for identifying grammar rules that match a search query. The method 500 can be executed by a search server (e.g., the search server 300 shown in FIG. 3). The method 500 may be implemented as a set of computer-readable instructions that are executed by a processing device (e.g., the processing device 370 shown in FIG. 3). The search server receives a search query (at 510). The search server analyzes the search query and identifies the entity types of the entities specified in the search query (at 520). At 530, the search server generates a mapping of the entity types and their start token positions within the search query to their end token positions in the search query. The search server utilizes the mapping to identify grammar rules that match the search query (at 560). If the search query matches a grammar rule, the search server performs an action associated with the grammar rule (at 580). In some implementations, prior to identifying the grammar rules at 560, the search server may retrieve a list that specifies a set of entity types that the search query should include (at 540). The search server can utilize the mapping to determine whether the search query includes each entity type specified in the list (at 550). In such implementations, the search server may only utilize the mapping to identify matching grammar rules if the search query includes every entity type, intent word, and modifier word specified in the list.

Referring to 510, the search server receives a search query. The search server may receive a search request that includes the search query. The search request can include additional information. For example, the search request may include contextual data that indicates a context of a mobile computing device that initiated the search request. Examples of contextual data include application IDs that identify the applications installed on the mobile computing device, sensor measurements such as location, time of day, etc. The search server may receive the search query directly from the mobile computing device or through a partner computing system that serves as an intermediary between the search server and the mobile computing device.

At 520, the search server analyzes the search query. The search server analyzes the search query to identify the entity type of any entity specified in the search query. The search server also analyzes the search query to identify any intent words or modifier words specified in the search query. Generally, the search server tokenizes the search query to generate tokens (at 522). At 524, the search server utilizes the tokens to form n-grams. Upon forming the n-grams, the search server identifies the entity types associated with the n-grams (at 526). The search server can also determine whether any of the n-grams correspond with an intent word or a modifier word (at 528).

Referring to 522, the search server can tokenize the search query to generate parsed tokens. The search server can use a tokenizer to tokenize the search query. The tokenizer can use various techniques to generate the tokens. In some examples, the tokenizer generates the tokens by splitting the characters of the search query with a given space delimiter (e.g., “ ”). The search server can perform various other operations on the search query. For example, the search server may perform stemming by reducing the words in the search query to their stem word or root word. The search server can perform synonym ization by identifying synonyms of search terms in the search query. The search server can also perform stop word removal by removing commonly occurring words from the search query (e.g., by removing “a,” “and,” etc.). The search server may also identify misspelled words and replace the misspelled words with the correct spelling. Some of the operations described herein may be referred to as ‘cleaning’ the search query.

Referring to 524, the search server can utilize the tokens to form n-grams. An n-gram may include one or more tokens. An n-gram that includes only one token may be referred to as a unigram. An n-gram that includes two tokens may be referred to as a bigram. N-grams with two or more tokens include tokens that appear sequentially. The search server can form n-grams by selecting individual tokens and/or by selecting tokens that appear in sequence in the search query. Table 6 illustrates an example search query and the n-grams that the search query may generate for the search query. In the example of Table 6, the search query is “The Dark Knight Christian Bale.”

TABLE 6
Example n-grams for a Search Query

| | |
|---|---|
| Unigrams | “The”, “Dark”, “Knight”, “Christian”, “Bale” |
| Bigrams | “The Dark”, “Dark Knight”, “Knight Christian”, “Christian Bale” |
| Trigrams | “The Dark Knight”, “Dark Knight Christian”, “Knight Christian |
| | Bale” |
| 4-grams | “The Dark Knight Christian”, “Dark Knight Christian Bale” |
| 5-gram | “The Dark Knight Christian Bale” |

At 526, the search server identifies the entity types associated with the n-grams. To identify the entity types associated with the n-grams, the search server may use an entity data store (e.g., the entity data store 320 shown in FIG. 3) that stores information regarding entities. For each entity, the entity data store can also store an entity type. For example, if the entity data store stores “The Dark Knight” entity, then the entity data store can also store that “The Dark Knight” entity is a movie entity. The search server can query the entity data store with the n-grams (at 526-1). Upon receiving the query, the entity data store can determine which n-grams correspond with an entity. For n-grams that correspond with an entity, the entity data store can return the entity type associated with the entity. Consequently, the search server receives entity types for n-grams that correspond with entities (at 526-2). Table 7 shows the entity types for an example search query. In the example of Table 7, the search query is “The Dark Knight Christian Bale.”

TABLE 7
Example Search Query with Entity Types

| 0 | 1 | 2 | 3 | 4 |
|---|---|---|---|---|
| The | Dark | Knight | Christian | Bale |

| | |
|---|---|
| Movie (0, 2) | Actor (3, 4) |

At 528, the search server can determine whether any of the n-grams (e.g., unigrams) are intent words or modifier words. To determine whether any of the n-grams are intent words or modifier words, the search server may use a keyword data store (e.g., the keyword data store 330 shown in FIG. 3) that stores intent words and modifier words. The search server can query the keyword data store with the n-grams (at 528-1). Upon receiving the query, the keyword data store can perform a search for intent words and modifier words that match the n-grams. If an n-gram matches an intent word or a modifier word, the keyword data store can provide an indication that the n-gram is an intent word or a modifier word. Consequently, the search server receives an indication for n-grams that are intent words or modifier words (at 528-2). In the example of Table 7, the search server determines that none of the n-grams are intent words or modifier words.

At 530, the search server generates a mapping of entity types and the start token positions of the entity types to the end token positions of the entity types. The mapping can also map intent words and the start token positions of the intent words to the end token positions of the intent words. Similarly, the mapping can also map modifier words and the start token positions of the modifier words to the end token positions of the modifier words. Table 8 shows an example mapping for “The Dark Knight Christian Bale” search query.

TABLE 8
Mapping of Entity Types and Start Token Positions of Entity
Types to End Token Positions of Entity Types

| Entity Type, Start Position | End Position |
|---|---|
| Movie, 0 | 2 |
| Actor, 3 | 4 |

The search server can use a variety of techniques to generate the mapping. In some implementations, the search server can perform the operations indicated by 532-536 to generate the mapping. At 532, the search server can generate a first mapping mechanism that maps a token start position and a token end position to an entity type, an intent word, or a modifier word. The first mapping mechanism may be referred to as a chart parse. The search server can use various techniques to generate the first mapping mechanism. In some implementations, the search server can generate the first mapping mechanism by using the Viterbi algorithm or any variant of the Viterbi algorithm. Alternatively, the search server can generate the first mapping mechanism by using any technique associated with the Earley parser. Moreover, the search server can generate the first mapping mechanism by using the Cocke-Younger-Kasami (CYK) algorithm or a variant of the CYK algorithm. Table 9 shows an example of the first mapping mechanism for “The Dark Knight Christian Bale” search query.

TABLE 9
First Mapping Mechanism (e.g., Chart Parse) maps Token Start
Positions and Token End Positions to Entity Types,
Intent Words, and/or Modifier Words

| (Start Position, End | Entity Type, Intent Word, |
|---|---|
| Position) | or Modifier Word |
| (0, 2) | Movie |
| (3, 4) | Actor |

The first mapping mechanism can be represented as a function that receives a token start position and a token end position as inputs and outputs an entity type, intent word, or modifier word that spans from the token start position to the token end position. Equation 4 illustrates a mathematical representation of the first mapping mechanism as a function.

f₁(x, y)→Entity Type, Intent Word or Modifier Word (4)
where x=token start position; and y=token end position

At 534, the search server can generate a second mapping mechanism that maps entity types, intent words, or modifier words to a token start position and a token end position. The search server can generate the second mapping mechanism by inverting the first mapping mechanism. Consequently, the second mapping mechanism may be referred to as an inverse of the first mapping mechanism. If the first mapping mechanism is referred to as a chart parse, then the second mapping mechanism may be referred to as an inverse chart parse. Table 10 illustrates an example of the second mapping mechanism for “The Dark Knight Christian Bale” search query.

TABLE 10
Second Mapping Mechanism (e.g., Inverse Chart Parse) maps
Entity Types, Intent Words, and Modifier Words to Token
Start Position and Token End Position

| Entity Type, Intent Word or | (Start Position, End |
|---|---|
| Modifier Word | Position) |
| Movie | (0, 2) |
| Actor | (3, 4) |

The second mapping mechanism can be represented as a function that receives an entity type, an intent word, or a modifier word as an input and outputs a token start position and a token end position. The token start position and the token end position represent a range of tokens throughout which the entity type, the intent word, or the modifier word span. Equation 5 illustrates a mathematical representation of the second mapping mechanism as a function.

f₂(Entity Type, Intent Word or Modifier Word)→x, y (5)
where x=token start position; and y=token end position

At 536, the search server generates a third mapping mechanism that maps entity types, intent words, or modifier words, and a token start position to a token end position. The search server can generate the third mapping mechanism by augmenting (e.g., transforming) the second mapping mechanism. If the second mapping mechanism is referred to as an inverse chart parse, then the third mapping mechanism may be referred to as an augmented inverse chart parse. Table 11 illustrates an example of the third mapping mechanism for the “The Dark Knight Christian Bale” search query.

TABLE 11
Third Mapping Mechanism (e.g., augmented inverse chart
parse) maps Entity Types, Intent Words, or Modifier
Words and their Start Token Positions to their End Token Positions

| (Entity Type, Intent Word, or Modifier | End |
|---|---|
| Word), Start Position | Position |
| Movie, 0 | 2 |
| Actor, 3 | 4 |

The third mapping mechanism can be represented as a function that receives an entity type, an intent word, or a modifier word along with a token start position. The token start position represents a location within the search query where the entity type, intent word, or modifier word starts. The function outputs a token end position that represents a location within the search query where the entity type, intent word, or modifier word stops. Equation 6 illustrates a mathematical representation of the third mapping mechanism as a function.

f₃(Entity Type, Intent Word or Modifier Word, x)→y (6)
where x=token start position; and y=token end position

In some implementations, the search server can generate the third mapping mechanism without explicitly generating the first mapping mechanism and the second mapping mechanism. In other words, the search server may generate the augmented inverse chart parse without explicitly generating the chart parse and the inverse chart parse. If the search server explicitly generates the first mapping mechanism and the second mapping mechanism, then the search server can purge the first mapping mechanism and the second mapping mechanism upon generating the third mapping mechanism. The search server can use the third mapping mechanism to determine the grammar rules that the search query satisfies. A benefit of using the third mapping mechanism is that the third mapping mechanism can be stored as a relatively compact data structure. Due to its compact nature, the third mapping mechanism requires relatively less memory to store. Hence, the third mapping mechanism can be stored in a cache of the processing device instead of being stored in the storage device.

In some implementations, the search query must include a particular set of entity types, intent words, and/or modifier words in order for the search server to identify the grammar rules that the search query matches. In such implementations, the search server can retrieve a list of entity types, intent words, and/or modifier words that the search query must include (at 540). At 550, the search server determines whether the search query includes each entity type, intent word, and modifier word specified in the list. If the search query includes all the entity types, intent words, and/or modifier words specified in the list, then the search server can proceed to 560. Otherwise, if the search query does not include all the entity types, intent words, and/or modifier words specified in the list, then the method 500 ends. Referring to 560, the search server can determine whether the search query includes the entity types specified in the list by querying the mapping generated at 530.

At 560, the search server utilizes the mapping generated at 530 to identify the grammar rules that match the search query. Utilizing the mapping refers to using the third mapping mechanism generated at 536. In other words, utilizing the mapping refers to using the augmented inverse chart parse. FIG. 5C illustrates a set of example operations that the search server can perform to identify the grammar rules that the search query matches.

At 580, the search server performs an action associated with the grammar rule that matches the search query. In some implementations, the action may be to retrieve an access mechanism associated with the matching grammar rule and transmit the access mechanism to the mobile computing device as a search result (at 580-1). If, at 560, the search server determines that the search query matches multiple grammar rules, then the search server can retrieve the access mechanism for each of the grammar rules. Hence, the search results may include multiple access mechanisms. To transmit the access mechanisms to the mobile computing device, the search server can instantiate a data container, write the access mechanisms to the data container, and transmit the data container to the mobile computing device. The data container can be a JSON object, an XML file, or the like. The data container may be referred to as a search result object (e.g., the search result object 390 shown in FIGS. 1 and 3).

In some implementations, the action may be to categorize the search query into a query category associated with the matching grammar rule (580-2). Each grammar rule may be associated with a query category. If, at 560, the search server determines that the search query matches a grammar rule, then the search server can retrieve the query category associated with the matching grammar rule and categorize the search query into the retrieved query category. Upon categorizing the search query into a particular query category, the search server can transmit (e.g., forward) the search request (e.g., search query) to another search server that is associated with that particular query category (e.g., the category-specific search server 150 shown in FIGS. 1 and 3). For example, if the search server categorizes a search query as a travel query, then the search server can transmit the search query to a category-specific search server that is configured to provide search results for travel-related search queries. If the search server categorizes the search query into multiple categories, then the search server may transmit the search query to multiple category-specific search servers. For example, if the search server categorizes a particular search query into a movie category and a book category, then the search server can transmit the search query to a second search server that provides movie-related search results and a third search server that provides book-related search results.

Referring to 580-2, upon transmitting the search query to a category-specific search server, the search server may receive search results from the category-specific search server. In some implementations, the search server may receive the search result object from the category-specific search server. If the search server receives the search result object from the category-specific search server, the search server can transmit (e.g., forward) the search result object to the mobile computing device without modifying the search result object. Alternatively, the search server may receive access mechanisms from the category-specific search server and write the access mechanisms to a data container that represents a search result object. Upon generating the search result object, the search server can transmit the search result object to the mobile computing device.

FIG. 5B illustrates an example search query 122, a mapping 590, and an example merged grammar tree 360. The search query 122 includes a movie entity and an application entity. The movie entity starts at token 0 and ends at token 2. The application entity starts at token 3 and ends at token 3. The mapping 590 maps the entity types and the start token positions of the entity types to the end token positions of the entity types. For example, the mapping 590 maps (movie, 0) to 2. Similarly the mapping 590 maps (application, 3) to 3. The search server 300 may generate the mapping 590 by executing the operations indicated at block 530 in FIG. 5A. Specifically, the mapping 590 may refer to the third mapping mechanism that the search server 300 generates by executing the operation indicated at 536 in FIG. 5A. The mapping 590 can also be referred to as the augmented inverse chart parse. In the example of FIG. 5B, the merged grammar tree 360 is a visual representation of two grammar rules: G1 and G2. In order to match the first grammar rule G1, the search query 122 must include a movie entity (M), an actor entity (A), and a genre (G). Similarly, in order to match the second grammar rule G2, the search query 122 should include a movie entity (M) and an application entity (AP).

FIG. 5C illustrates example operations 560 that the search server can perform to identify the matching grammar rule(s). The operations 560 may be a set of computer-readable instructions that the search server can execute. The operations 560 utilize the mapping of entity types and their token start positions to their token end positions (e.g., the mapping 590). At 562, the search server instantiates a token index (T) and sets T to 0. The search server also instantiates a level index (L) and sets L to 1. At 564, the search server identifies an entity type in the search query that starts at T. In other words, the search server identifies an entity type with a token start position that is equal to T. The search server can query the mapping with T and receive the entity type that starts at T. For example, the search server can query the mapping 590 with ‘0’ and receive ‘movie’ as the entity type that starts at token position 0.

At 566, the search server determines whether the merged grammar tree 360 includes the entity type at a level indicated by the level index (L). For example, the search server can determine whether the merged grammar tree 360 includes a node for the movie entity at level 1. Referring to the example of FIG. 5B, the search server can determine that the merged grammar tree 360 includes a node for the movie entity at level 1.

If the merged grammar tree includes the entity type at the level indicated by the level index, then the search server retrieves an end token position for the entity type from the mapping (at 568). The search server can query the mapping with the entity type and the token index, and receive a token end position for the entity type. Referring to the example of FIG. 5B, the search server can query the mapping 590 with (M, 0) and receive a token end position of 2.

At 570, the search server sets the token index to one plus the token end position determined at 568. Moreover, the search server increments the level index by one. Referring to the example of FIG. 5B, the search server sets the token index to 3 (1+2) and increments the level index from 1 to 2.

At 572, the search server determines whether the token index points to null (e.g., end of search query) and the level index points to an end of a grammar rule. The search server can determine that the token index points to null if the search server queries the mapping with the token index and the mapping returns null. Referring to the example of FIG. 5B, the search server can query the mapping 590 with 3. Since the mapping 590 includes (AP, 3), the token index of 3 does not point to null. Similarly, since the level index of 2 points to AP, G, and A in the merged grammar tree 360, the level index does not point to the end of a grammar rule. Since neither of the conditions specified at 572 are met, the search server performs operations 564-572 again.

During the second iteration of operation 564, the search server identifies the entity type that starts at the token index of 3. The search server can query the mapping 590 with ‘3’ and receive application (AP) as the entity type that starts at token position 3. At 566, the search server determines whether the merged grammar tree 360 includes a node for AP at level 2. Since the merged grammar tree 360 includes AP at level 2, the search server proceeds to operation 568. At 568, the search server retrieves the end token position of AP from the mapping 590. The search server can query the mapping 590 with (AP, 3) and receive 3 as the end token position of AP. At 570, the search server sets the token index T to 4 (1+3) and the level index L to 3 (2+1). At 572, the search server determines whether the token index points to null and the level index points to the end of grammar rule. The search server can query the mapping 590 with 4 (i.e., the token index). Since the mapping 590 does not include any entity types that start at token position 4, the mapping 590 returns null. Hence, after the second iteration, the token index points to null. Similarly, the level index of 3 points to the end of grammar rule G2. Therefore, both the conditions indicated by operation 572 are met.

If, at 572, the search server determines that both conditions are met, the search server determines that the search query matches the grammar rule that the level index points to. In the example of FIG. 5B, the search server determines that the search query 122 matches the grammar rule G2. The search server can perform additional or alternative operations to identify the grammar rules that the search query satisfies.

Once the search server determines that the search query does not include an entity type that corresponds with a particular node, the search server may refrain from wasting computing resources determining whether the search query includes entity types that correspond with nodes that descend from that particular node. In the example of FIG. 5B, once the search server determines that the search query 122 does not include G at level 1, the search server does not waste computing resources in determining whether the search query includes M and A at level 2. Similarly, once the search server determines that the search query 122 does not include AP at level 1, the search server does not waste computing resources to determine whether the search query includes M at level 2.

The search server does not check the search query for entity types that correspond with nodes in a subtree if the search query does not include the entity types that correspond with the root node of the subtree. By not checking the search query for entity types corresponding with every single node in the merged grammar tree, the search server reduces the amount of time required to identify the grammar rules that match the search query. A benefit of using the augmented inverse chart parse is that the search server is much faster than conventional rule-based search systems at determining that the search query does not match a set of grammar rules. In other words, the search server consumes lesser time and fewer computing resources than conventional rule-based search systems to determine that the search query has failed to match a grammar rule.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus,” “computing device,” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A search server comprising:
a network communication device; and
a processing device that executes computer-readable instructions that, when executed by the processing device, cause the processing device to:
receive a first grammar rule and a second grammar rule via the network communication device, wherein the first grammar rule specifies a first set of entity types and the second grammar rule specifies a second set of entity types, and wherein the intersection of the first set and the second set comprises at least one entity type;
generate a first grammar tree to represent the first grammar rule and a second grammar tree to represent the second grammar rule, wherein a first root node of the first grammar tree and a second root node of the second grammar tree are identical;
merge the first grammar tree and the second grammar tree to form a merged grammar tree that represents a union of the first set of entity types and the second set of entity types; and
optimize the merged grammar tree by purging duplicate nodes from each level of the merged grammar tree.

2. The search server of claim 1, wherein generating the first grammar tree comprises:
instantiating a tree data structure;
identifying the first set of entity types;
instantiating a tree node for each entity type in the first set of entity types; and
instantiating tree edges to connect the tree nodes that correspond with adjacent entity types.

3. The search server of claim 1, wherein the first root node of the first grammar tree represents a starting point for the first grammar rule and the second root node of the second grammar tree represents a starting point for the second grammar rule.

4. The search server of claim 1, wherein merging the first grammar tree and the second grammar tree comprises:
purging the second root node of the second grammar tree; and
appending child nodes of the second root node to the first root node of the first grammar tree as child nodes of the first root node.

5. The search server of claim 4, wherein merging the first grammar tree and the second grammar tree further comprises:
determining a first value that represents a size of the first grammar tree;
determining a second value that represents a size of the second grammar tree; and
determining that the second value is smaller than the first value.

6. The search server of claim 1, wherein optimizing the merged grammar tree comprises:
determining that a first node and a second node on a particular level of the merged grammar tree are identical;
purging the second node; and
appending child nodes of the second node to the first node as child nodes of the first node.

7. The search server of claim 1, wherein the computer-readable instructions further cause the processing device to:
receive a search query via the network communication device; and
utilize the merged grammar tree to determine whether the search query satisfies the first grammar rule and/or the second grammar rule.

8. The search server of claim 7, wherein determining whether the search query satisfies the first grammar rule and/or the second grammar rule comprises:
tokenizing the search query to generate tokens;
utilizing the tokens to form n-grams;
identifying entity types associated with the n-grams;
generating a mapping of the entity types and token start positions of the entity types to token end positions of the entity types; and
utilizing the mapping to determine whether the search query matches the first grammar rule and/or the second grammar rule.

9. The search server of claim 8, wherein generating the mapping comprises:
generating a first mapping mechanism that maps the token start positions and token end positions to the entity types;
generating a second mapping mechanism by inverting the first mapping mechanism, wherein the second mapping mechanism maps the entity types to the token start positions and the token end positions; and
generating a third mapping mechanism by transforming the second mapping mechanism, wherein the third mapping mechanism maps the entity types and the token start positions of the entity types to the token end positions of the entity types.

10. The search server of claim 8, wherein utilizing the mapping comprises:
initiating a token index and setting the token index to zero;
initiating a level index and setting the level index to one;
querying the mapping with the token index to identify the entity type that starts at the token index;
determining that the merged grammar tree includes a node for the identified entity type at a level indicated by the level index;
retrieving the end token position of the entity type from the mapping;
setting the token index to one plus the end token position;
incrementing the level index by one; and
determining that the token index points to null and the level index points to the end of the first grammar rule or the second grammar rule.

11. The search server of claim 7, wherein the computer-readable instructions further cause the processing device to:
determine a set of entity types that the search query must include in order to utilize the merged grammar tree for grammar matching; and
store the entity types in the set as a list in a storage device.

12. The search server of claim 11, wherein utilizing the merged grammar tree comprises:
retrieving the list from the storage device; and
determining that the search query includes the entity types specified in the list.

13. A computer program product encoded on a non-transitory computer readable storage medium comprising instructions that when executed by a processing device cause the processing device to perform operations comprising:
receiving a first grammar rule and a second grammar rule via a network communication device, wherein the first grammar rule specifies a first set of entity types and the second grammar rule specifies a second set of entity types, and wherein the intersection of the first set and the second set comprises at least one entity type;
generating a first grammar tree to represent the first grammar rule and a second grammar tree to represent the second grammar rule, wherein a first root node of the first grammar tree and a second root node of the second grammar tree are identical;
merging the first grammar tree and the second grammar tree to form a merged grammar tree that represents a union of the first set of entity types and the second set of entity types;
optimizing the merged grammar tree by purging duplicate nodes from each level of the merged grammar tree;
receiving a search query via the network communication device; and
utilizing the merged grammar tree to determine whether the search query satisfies the first grammar rule and/or the second grammar rule.

14. The computer program product of claim 13, wherein generating the first grammar tree comprises:
instantiating a tree data structure;
identifying the first set of entity types;
instantiating a tree node for each entity type in the first set of entity types; and
instantiating tree edges to connect the tree nodes that correspond with adjacent entity types.

15. The computer program product of claim 13, wherein merging the first grammar tree and the second grammar tree comprises:
purging the second root node of the second grammar tree; and
appending child nodes of the second root node to the first root node of the first grammar tree as child nodes of the first root node.

16. The computer program product of claim 13, wherein determining whether the search query satisfies the first grammar rule and/or the second grammar rule comprises:
tokenizing the search query to generate tokens;
utilizing the tokens to form n-grams;
identifying entity types associated with the n-grams;
generating an augmented inverse chart parse that maps the entity types and token start positions of the entity types to token end positions of the entity types; and
utilizing the augmented inverse chart parse to determine whether the search query matches the first grammar rule and/or the second grammar rule.

17. The computer program product of claim 16, wherein generating the augmented inverse chart parse comprises:
generating a chart parse that maps the token start positions and token end positions to the entity types;
generating an inverse chart parse by inverting the chart parse, wherein the inverse chart parse maps the entity types to the token start positions and the token end positions; and
generating the augmented inverse chart parse by augmenting the inverse chart parse, wherein the augmented inverse chart parse maps the entity types and the token start positions of the entity types to the token end positions of the entity types.

18. The computer program product of claim 16, wherein utilizing the augmented inverse chart parse comprises:
initiating a token index and setting the token index to zero;
initiating a level index and setting the level index to one;
querying the augmented inverse chart parse with the token index to identify the entity type that starts at the token index;
determining that the merged grammar tree includes a node for the identified entity type at a level indicated by the level index;
retrieving the end token position of the entity type from the augmented inverse chart parse;
setting the token index to one plus the end token position;
incrementing the level index by one; and
determining that the token index points to null in the augmented inverse chart parse and the level index points to the end of the first grammar rule or the second grammar rule.

19. The computer program product of claim 16, wherein the operations further comprise:
determining a minimum set of entity types for the search query to satisfy at least one of the first grammar rule and the second grammar rule; and
storing the entity types in the minimum set as a list in a storage device.

20. The computer program product of claim 19, wherein utilizing the merged grammar tree comprises:
retrieving the list from the storage device; and
querying the augmented inverse chart parse with the entity types in the list to determine that the search query includes the entity types specified in the list.

21. A computer-implemented method comprising:
receiving, at a processing device, a search request via a network communication device, the search request comprising a search query with one or more search terms;
tokenizing, by the processing device, the search query to generate tokens;
generating, at the processing device, n-grams from the tokens, wherein each of the n-grams includes one or more tokens;
querying, by the processing device, an entity data store stored in a storage device with the n-grams to identify entity types associated with the n-grams;
generating, at the processing device, an augmented inverse chart parse that maps the entity types and start token positions of the entity types to end token positions of the entity types; and
utilizing, by the processing device, the augmented inverse chart parse to identify grammar rules that the search query matches.

22. The computer-implemented method of claim 21, wherein generating the augmented inverse chart parse comprises:
generating a chart parse that maps the token start positions and token end positions to the entity types;
generating an inverse chart parse by inverting the chart parse, wherein the inverse chart parse maps the entity types to the token start positions and the token end positions; and
generating the augmented inverse chart parse by augmenting the inverse chart parse, wherein the augmented inverse chart parse maps the entity types and the token start positions of the entity types to the token end positions of the entity types.

23. The computer-implemented method of claim 21, wherein utilizing the augmented inverse chart parse comprises:
initiating a token index and setting the token index to zero;
initiating a level index and setting the level index to one;
querying the augmented inverse chart parse with the token index to identify the entity type that starts at the token index;
determining that a merged grammar tree includes a node for the identified entity type at a level indicated by the level index, wherein the merged grammar tree represents a plurality of grammar rules;
retrieving the end token position of the entity type from the augmented inverse chart parse;
setting the token index to one plus the end token position;
incrementing the level index by one; and
determining that the token index points to null and the level index points to the end of one of the grammar rules represented by the merged grammar tree.

24. The computer-implemented method of claim 23, further comprising:
receiving the plurality of grammar rules, wherein each grammar rule specifies a set of entity types;
for each grammar rule, generating a grammar tree that represents the grammar rule, wherein each node of the grammar tree corresponds with an entity type specified in the grammar rule;
merging the grammar trees to form a merged grammar tree that represents a union of the entity types specified in the grammar rules; and
optimizing the merged grammar tree by purging duplicate nodes from each level of the merged grammar tree.

25. The computer-implemented method of claim 23, further comprising:
determining a set of entity types that the search query must include in order to perform grammar matching; and
storing the entity types from the set as a list in the storage device.

26. The computer-implemented method of claim 25, further comprising:
retrieving the list from the storage device;
querying the augmented inverse chart parse with the entity types in the list; and
utilizing the augmented inverse chart parse for grammar matching if the augmented inverse chart parse includes all the entity types specified in the list.
